(19) United States
(12) Patent Application Publication
(10) Pub. No.: US 2006/0170134 A1
(43) Pub. Date: Aug. 3, 2006

(54) PROCESS FOR OVER-MOLDING ONTO CROSSLINKED POLYMERS

(76) Inventors: William W. Rowley, Chagrin Falls, OH (US); Richard T. Seman SR., Newbury, OH (US)

Correspondence Address: BUCKINGHAM, DOOLITTLE & BURROUGHS, LLP, 50 S. MAIN STREET, AKRON, OH, 44308, US

(21) Appl. No.: 10/905,974

(22) Filed: Jan. 28, 2005

(51) Int. Cl. B29C 45/14; B29C 71/02

(52) U.S. Cl. 264/265; 264/236

(57) ABSTRACT

The invention described herein pertain generally to a process by which an injection overmolded profile may be materially bonded to a previously crosslinked profile.

### TECHNICAL FIELD

The invention described herein pertains generally to a process for injection over-molding a second polymer onto a first polymer wherein the bond formed between the polymers is a chemical bond (as distinguished from a physical bond) for which the second polymer has been cross-linked to at least 65% prior to injection overmolding. In one aspect of this invention, the tube or other profile (including both solid and apertured profiles) is flash heated to a temperature at the upper end of its extrusion processing temperature, followed quickly by injection over-molding, forming a strong bond, preferably a material-to-material bond with the over-molded polymer. Optionally, the flash heating step is preceded by a corona treatment, flame treatment or ozone treatment of the surface of the first profile.

### BACKGROUND OF THE INVENTION

The trend, particularly in plumbing today, is to shift from thermoplastic materials to thermoset polymers, e.g., crosslinked polyethylene wherein at least a portion of the polymer is crosslinked, for example approximately 65% thermoset/35% thermoplastic. However, this shift in materials has a significant impact on processing operations impacting these materials and there are several processing changes which must be incorporated in order to fabricate acceptable parts. The Prior Art teaches that thermoplastic material can chemically bond to itself. However, as the percentage of cross-linking increases, there is less thermoplastic remaining to form this chemical bond. In the Prior Art, as illustrated for example by U.S. Pat. Nos. 5,895,695 and 6,287,501, the conventional wisdom was believed to be the recognition of the need to form the over-molded section at the earliest time when the base underlying polymeric profile was the least crosslinked. When cross-linking using radiation, this is before any cross-linking occurs. With silane cross-linking, this is typically after extrusion, but before cross-linking is complete. In a preferred embodiment as taught in the previously identified plumbing patents, the tube and the over-molded plastic will both be essentially about 35% crosslinked, and subsequently permitted to complete the cross-linking process after injection over-molding.

However, there are applications where the tube or other profile is more than 65% crosslinked and an injection over-molding operation is desired. To date, there is no teaching in the art as to how this may be accomplished. By using the technology described in this application, it is now possible to injection over-mold onto profiles having a degree of cross-linking of at least 65% or greater, and still result in a material-to-material bond between the injection over-molded polymer (which may become crosslinked or more fully crosslinked) with the crosslinked underlying profile which had been previously crosslinked to 65% or greater.

### SUMMARY OF THE INVENTION

In accordance with the present invention, there is provided a method by which a material-to-material bond may be achieved by injection over-molding onto polymeric material which is at least 65% crosslinked prior to the step of injection over-molding. The method involves flash heating of the crosslinked material optionally with prior corona treatment of the same.

Additionally, in one aspect of the invention, the polymeric base tubular material is electron beamed to a cross-linking percentage of at least 65% or more, followed by flash heat treatment, optionally preceded by corona treatment, and ultimately injection over-molding a second polymer, which may be the same or different from that of the polymeric base material, forming a material-to-material bond between the over-molded polymer and the base polymer. The over-molded polymer is typically a partially crosslinked polymer, or at least a cross-linkable polymer, often using silane as the cross-linking agent.

The final cross-linking percentage of the base polymer and the over-molded polymer are often similar, to within a few percent of each other, although there is not a requirement of this invention.

Therefore, it is an object of the invention to describe a process for injection over-molding cross-linked profiles which includes the following steps: (a) heating a portion of a profile of a first polymer cross-linked to at least 65% to a temperature which raises at least the temperature of the skin of the profile portion of the first polymer from a first temperature to a second higher temperature for a duration of time to heat that portion of the skin to a temperature below which the polymer begins to degrade; (b) inserting at least a portion of the heated portion of the profile (optionally having a passageway disposed therethrough) while that portion of the profile is still in a heated condition, at least partially into a mold and if the profile contains a passageway, at least partially onto a suitably configured mandrel, the mold containing a void for receiving a second polymer, the void co-acting with the optional mandrel and the profile to define an over-molding shape; (c) injection molding a second polymer over the heated first profile and the optional mandrel in the void of the mold; and (d) optionally cross-linking the second polymer to a final degree of cross-linking. The above sequence is optionally preceded by pre-treatment of at least a portion of the profile which ultimately is heat activated and subsequently injection over-molded, said pre-treatment selected from the group consisting of corona, ozone and flame treatment.

It is still a further object of this invention in a more generic sense to describe a process for injection over-molding onto cross-linked profiles comprising the steps of: (a) activating a skin surface of a portion of the profile of a first polymer previously cross-linked to at least 65% with an activation means so that the skin surface of that profile portion is receptive to a material-to-material bond with an injection overmolded second polymer; (b) inserting at least a portion of the activated portion of the profile while the heated portion is still in an activated condition, at least partially into a mold, the mold containing a void for receiving a second polymer, the void co-acting with the profile to define an over-molding shape; (c) injection molding a second polymer over the profile in the void of the mold forming a material-to-material bond with the first polymer; and (d) optionally cross-linking the second polymer to a final degree of cross-linking. It is recognized that this last step of cross-linking said second polymer is not required in all aspects of this invention.

These and other objects of this invention will be evident when viewed in light of the drawings, detailed description, and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of a corona treatment apparatus impinging a corona discharge onto the skin of a highly cross-linked polymeric profile;

FIG. 2 is a perspective view of an electrical heating apparatus illustrating the flash heating step with a highly cross-linked polymeric tube penetrating into a cavity therein;

FIG. 3 is a cross-section view of a plastic tube showing one connector over-molded onto a highly cross-linked polymeric tube;

FIG. 4 is a side view of the tube of FIG. 3 including a nut shown in cross-section positioned on the tube and retained in proximity to the sealing surface via protuberances on the connector;

FIG. 5 is a top view of one half of a mold used in the process of over-molding a nose cone onto a highly cross-linked plastic tube;

FIG. 6 is a view similar to FIG. 5 showing the highly cross-linked plastic tube inserted over the mandrel in the mold;

FIG. 7 is a view similar to FIG. 6 with the nose cone shown over-molded onto the highly cross-linked plastic tube;

FIG. 8 is a side view shown in partial cross-section of an over-molded nut;

FIG. 9 is a view similar to FIG. 3 showing the nose cone in cross-section and the highly cross-linked tube having an overbraid; and

FIG. 10 is a side view shown in partial cross-section of an over-molded threaded connector.

### DETAILED DESCRIPTION OF THE INVENTION

Referring now to the drawings wherein the showings are for purposes of illustrating the preferred embodiment of the invention only and not for purposes of limiting the same, the figures show cut lengths of plastic tubing which have over-molded components as well as the process used to achieve such a product. While the figures illustrate tubes, there is no reason to limit the invention to such, the tube merely being illustrative of one profile applicable in the practice of this invention. Similarly, while the figures illustrate either sealing surfaces or overmolded internally-threaded connectors as the overmolded configuration and this also is merely illustrative of one profile applicable in the practice of this invention. More generically, the invention relates to activating the surface of a first profile by “flash” heating or other activating treatment, followed by subsequent injection overmolding of a second profile over at least a portion of the flash-heated segment of the first profile.

As used in this invention, the term “highly cross-linked” means a polymer which has been previously cross-linked to approximately 65% or higher while the term “flash” heating means the application of heat or other form of radiant energy by which at least the surface of the initial profile is raised from an initial temperature to a subsequent higher temperature within a relatively short period of time, typically on the order of a few seconds (e.g., 0.01 to 60 seconds, more preferably 1 to 20 seconds). Corona treatment as used in this application means the application of a corona discharge onto the surface of a polymeric surface which typically introduces polar groups into the surface, which increases the surface energy, and as a consequence, improves the wettability and adhesion. It is believed, without being held to any one theory of operation, that the main chemical mechanism of corona treatment is oxidation. A corona is formed when a large electric field ionizes and otherwise excites the components of air at atmospheric pressure. A corona is thus, a particular type of low temperature plasma. The corona contains a variety of positively charged, negatively charged and neutral species in different energetic states. Excited species in the corona impact the surface of the plastic and cause chemical changes in a very thin layer about 1 micrometer deep. These reactions are oxidation and unsaturation as well as some crosslinking and chain scission.

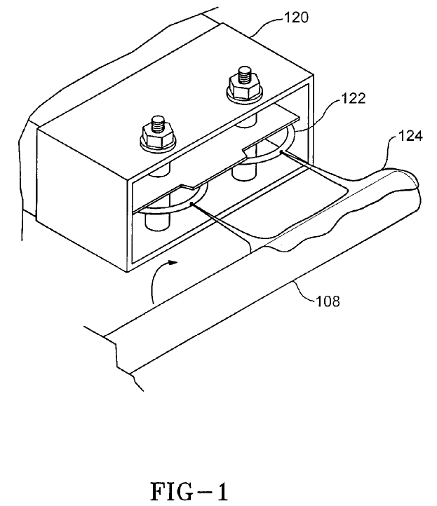

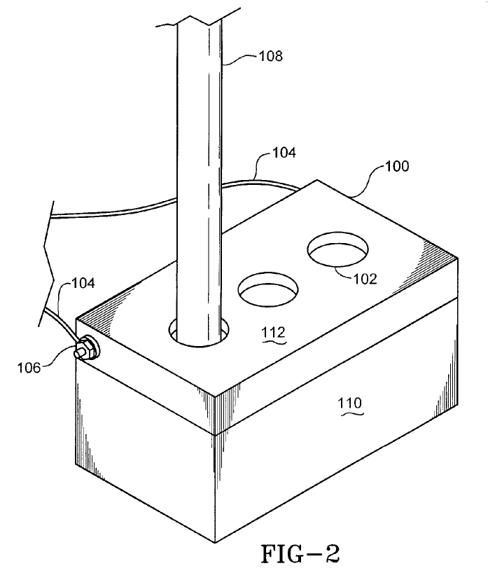

Prior to the step of injection over-molding and illustrated in FIG. 3, the connector 10 will have its tubing segment 18 crosslinked to a degree of at least 65% or greater, a percentage which was previously believed to not permit the formation of a material-to-material bond by injection over-molding. The leak-proof engagement of nose cone 2 with tube 18 is effected by a employing a flash preheating step about the external periphery of the over-molded section 6 of tube 18. When using silane as the cross-linking agent for polyethylene, this flash preheating step involved heating about the periphery at 550° F. for approximately 10 seconds, although it is recognized that this temperature and duration will vary depending on the amount of cross-linking agent contained in the tube, the composition of the polymer, and thickness of the tube. It is also recognized that there is an inverse relationship to the temperature of the electric resistance heater used and the duration of exposure to that temperature, e.g., when using higher temperatures, shorter durations are employed and vice-versa. As illustrated in FIG. 2, flash preheating may involve insertion of a highly crosslinked tube 108 into an electric resistance heater block 100 having a top 112 and bottom 110 component. Current is transferred to the block via electrical wires 104 with connectors 106. The heating block typically contains at least one, and preferably more than one apertured openings 102. Optionally, and not required, the over-molded section 6 of tube 18 is corona treated prior to flash heating as illustrated in FIG. 1 which employs a corona treatment device 120 with corona generator 122 shown impinging on the surface of the crosslinked polymeric tube 108 in a diffuse manner 124 with rotation of the tube illustrated by the clockwise arrow, although the direction of rotation plays no role in this invention.

The optional use of a corona treatment is to clean, oxidize and activate the surface of a polymer. In one sense, a corona treatment system can be thought of as a capacitor. High voltage is applied to the electrode. Between the electrode and the polymer surface is a dielectric medium, namely air. The voltage buildup on the electrode ionizes the air in the gap, creating the highly energized corona. This excites the air molecules, re-forming them into a variety of free radicals, which then bombard the surface, increasing its polarity by distributing free bond sites across it. Other pre-treatment modes may employ flame treatment or ozone treatment of the surface.

In this manner, it is possible to obtain a material-to-material bond, thereby effecting the leak-proof attachment of the nose cone to the tube, even when the portion of the tube to which the injection over-mold is applied is crosslinked to at least 65% prior to the step of injection over-molding. The resulting over-molded portion of the connector is crosslinked by means known in the art, e.g., silane cross-linking, radiation cross-linking, etc. Therefore, what has been shown is the ability to form a bond using base material which is at least partially crosslinked to 65% before the over-molding process, followed by further cross-linking subsequent to the leak-proof attachment.

In a preferred embodiment, the over-molded polymer will either be silane PEX or irradiation PEX. Peroxide PEX is also an option. Silane PEX materials are often referred to as moisture cure materials because they crosslink when exposed to water. In this method, silane-grafted polyethylene is first combined with the catalyst master batch and injection molded onto the already crosslinked polymeric material. Once the over-molding operation has been completed, cross-linking is accomplished over time, although exposing the product to moisture will accelerate the process. Irradiation PEX is similar in some aspects to silane PEX in that it must first be injection molded with cross-linking achieved by bombarding the product with electromagnetic (gamma) or high-energy electron (beta) radiation. Peroxide PEX derives its name from the class of chemicals used to achieve cross-linking of the polyethylene. Peroxide materials are incorporated into the base polyethylene resin and by heating the polyethylene above the decomposition temperatures of the peroxides, free radicals are produced which initiate the cross-linking process. The Engel method is one subset of this method of cross-linking. In this method, chemical cross-linking occurs during the manufacturing processing when the polyethylene is in its amorphic state (above the crystalline melting point). This method is touted as providing more precise control of the degree of cross-linking resulting in a more uniform product when compared to a crosslinked product wherein the cross-linking was effected during a post-molding step.

As used in this application, “flash heating” is defined as the time and temperature at which the exterior of the cross-linked tube becomes receptive to the formation of a chemical-to-chemical bond. The temperature needed to successfully achieve a material-to-material bond will depend on the nature and composition of the underlying material as well as that of the injection over-molded material. For example, when the underlying material is polyethylene which has been crosslinked to at least 65%, the temperature of the radiation heating device preferred for the short duration heating is approximately 550° F. It is recognized that the crystalline melting temperature of high density polyethylene is between 266-278° F., and therefore, this heating is approximately double that of the polymer's melting temperature. It is also recognized that the extrusion processing temperature for high density polyethylene ranges between 350-500° F. for injection molding and from 350-525° F. for extrusion processing. Therefore, it is seen that the degree of heating is at the upper end of the processing regime for this particular polymer in its non-cross-linked state. It is appreciated that even higher processing temperatures could be employed, but the duration time exposure would correspondingly need to be decreased, the two parameters being in inverse relationship to each other. The amount of pressure needed to successfully injection over-mold will also be dependent upon the degree of cross-linking of the material which is being pushed through the injection molding equipment, with pressure ranging between 100-500 psi depending upon the melt temperature employed which can range from 350-450° F. for silane PEX.

For polypropylene resins, the melt temperature is approximately 334-340° F. The associated temperatures and pressure described previously for high density polyethylene would have to be appropriately modified higher. Similar considerations apply for other polyolefin resins.

The time between the application of heat and the application of pressure is also important. The external peripheral temperature of the skin of the tube must not drop to such an extent as to render the flash heating step irrelevant, although some degree of heat loss is inevitable between the removal of the tube from a heating environment into the cavity of a mold wherein the injection molding step will be performed. The time between the two operational steps is dependent once again, upon the ability of the polymeric tube to retain heat, which is a function of the thickness of the part which was heated, the temperature of the external environment, the physical proximity of the heating device and the injection molding equipment, etc. In general, this time should be maintained to a minimal amount of time, generally less than one minute.

The preferred polymer in this invention is polyethylene. The main features which influence the properties of polyethylene are (1) the degree of branching in the polymer; (2) the average molecular weight; and (3) the molecular weight distribution. Polyethylene is partially amorphous and partially crystalline. The percent crystallinity has a marked effect on physical properties. Side chain branching is the key factor controlling the degree of crystallinity. High density polyethylene (HDPE) has fewer side-chain branches than low density polyethylene (LDPE), and therefore, a more tightly packed structure and a higher degree of crystallinity can be obtained. HDPE is characterized as being a highly crystalline material, perhaps as much as 85% while LDPE exhibits crystallinities as low as 50%. The amount of branching is controlled in the LDPE and HDPE processes in order to adjust crystallinity and physical properties.

The density of polyethylene affects many physical properties. In general, increasing density increases stiffness, tensile strength, hardness, heat and chemical resistance, opacity and barrier properties, but reduces impact strength and stress-crack resistance.

As used in this application, low density polyethylene will mean an ethylene polymer which has a specific gravity of about 0.89 to 0.915, a tensile strength of about 1,500 psi; an impact strength over 10 ft-lb/in./notch; a thermal expansion of 17×10⁻⁵ in/in/° C. When discussing high density polyethylene, an ethylene polymer which has a specific gravity of about 0.94 to 0.95, a tensile strength of about 4,000 psi; impact strength of 8 ft-lb/in/notch. It is of course recognized, that it is possible to use materials which are a blend of various polyethylenes or other compatible materials in many different ratios. When discussing crosslinked polyethylene, an ethylene polymer, either low or high density, will be intended wherein the polymer has been either exposed to radiation with electron beam or gamma rays, cross-linking taking place through a primary valence bond, or by chemical cross-linking means, such as by using an organic peroxide, or by using silane. The range of cross-linking for the base tube will be at least 65%, and often higher, e.g., 70-75%. Depending on the degree of pre-treatment prior to flash heating, the cross-linking percentage for the base tube can be as high as 90%. The over-molded material is generally not crosslinked or minimally crosslinked at the point of injection over-molding, although the limitation is generally restricted only by the flowability of the crosslinked polymer in the runners of the injection molding equipment. From a practical standpoint, this means that that the over-molded material will be crosslinked to a degree of generally less than 50% during the injection over-molding step, although if higher pressures are tolerated by the equipment, it may be possible to injection over-mold polymer that is less than 60%. Post-injection molding steps generally include further cross-linking of the over-molded polymer, particularly if the polyethylene uses silane as the cross-linking agent or the over-molded polymer is crosslinked by exposure to electron beam radiation. Often, the post-injection molding processing will also increase the percentage of cross-linking in the base polymer. It is recognized however, that the post-injection molding step of further cross-linking is a preferred embodiment, and not necessarily required.

As seen in FIG. 3, a plumbing connection 10 is shown having a plastic nose cone 2 at one end which is secured to plastic tube 18 having two opposed ends 20, 22 in a leak-proof manner. Tubing segment 4, the portion of the tube 18 which is not attached to nose cone 2, can be of any desired length and this dimension plays no part in the invention. The nose cone 2 will have a front face 16, and a conical or radiused sealing surface 14 which terminates at shelf 12. The inner surfaces of cylindrical rear surface 8 and radiused surface 6 are used to affix the nose cone in a leak-proof manner to the corresponding section of the outer surface of tubing segment 18. Nose cone 2 has an inner diameter D₂ which essentially matches the outer diameter of tube 18. The inner diameter D₁ of tube 18 will be smaller than of D₂ by a thickness t of the tube.

As shown in FIG. 4, a nut 26 having a plurality of threads 28 is shown which is used to effect sealing engagement with a mating orifice. In one embodiment of the invention, the connector will optionally have at least one ridge 32 molded into the connector to retain an appropriately sized nut.

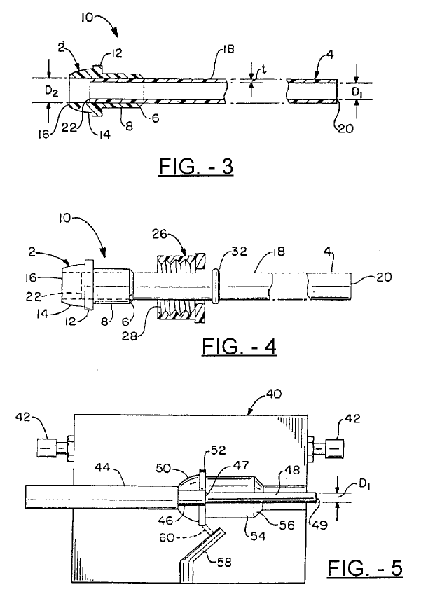

FIG. 5 shows one preferred embodiment of one-half of a mold 40 which would be effective in the over-molding process. The mold comprises a mandrel 44 having extending portions 46, 48 and terminating at a point outside the mold 40. It is not necessary that the mandrel extending portion have two different diameters as shown in FIG. 5, although this is preferred. At least a portion of the extending mandrel will have an outer diameter which essentially matches the inner diameter of the plastic tube, to permit the insertion of the tube onto the extending portion of the mandrel. The mold will have a radiused or conical base 50 which will form the sealing surface of the nose cone terminating in a mold shelf recess 52. Cylindrical mold portion 54 extends from this shelf recess and terminates in radiused mold portion 56. Over-molding feed conduit 58 is used to transfer flowable polymer from a source (not shown) into mold 40 via transfer conduit 60 shown in the Figure to be at the location of mold shelf recess 52, although there is no reason to limit the location to this point, other entry points being satisfactory depending upon design criterion and location of the parison. Connectors 42 are used for heating and optionally cooling of the mold.

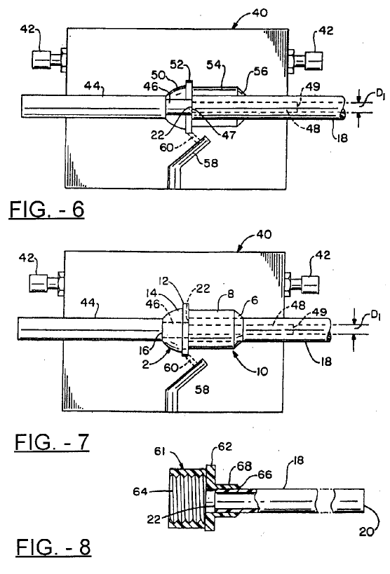

FIG. 6 shows the positioning of the plastic tube 18 onto the extending portion 48 of the mandrel 44 terminating at the terminal shelf 47 of the first larger extending portion 46 of the mandrel 44 while FIG. 7 shows the product after the over-molding process has been completed. It should be recognized that the precise location of the first terminal shelf 47 of the first extending portion 46 of the mandrel 44 need not coincide with the location of nose cone shelf 12, although it often will be in the vicinity thereof. In some instances, the extending mandrel portion will only be the second smaller diametered section, and the first extending portion will be eliminated completely.

In operation, the mold cycle times and temperatures used will be dependent upon the composition of the materials used and the geometry of the part(s) being molded as well as the degree of dimensional control required for the molded product. It is possible to have a cycle time range from five seconds to several minutes depending on the curing time for the molded material. In general for crosslinked polyethylene tubing, the temperatures used will range from 350° F. melt up to 540° F. although similar operations variables which were discussed for the mold cycle time are equally applicable here. Molding pressure will also be subject to similar considerations, and for crosslinked polyethylene, can range from 200 psi to 2,000 psi (hydraulic). In general, the colder the melt, the higher the pressure which is required to fill and pack the mold. If the part which is to be molded has a very thick section, then it may be desirable to use a low melt temperature, high melt pressure and as low a cycle time as possible. Given the interactivity between the above variables in an injection molding process, the range of the processing variables is almost limitless within broad guidelines and within the skill of those in the art.

While the above discussion has focused attention on the over-molding of a nose cone, there is no need to limit the invention to such. In fact, as shown in FIG. 8, an over-molded nut is shown, said nut having been formed by analogous processing to that described previously for nose cones. The over-molded nut 61 is shown affixed to tube 18, the nut containing a threaded bore 64 and a shoulder 62. The inner surfaces of the barrel portion 68 and radiused taper 66 are used to affix the nut in a leak-proof manner to the corresponding section of the outer surface of tubing element 18. This nut in a preferred embodiment will be glass-filled polyethylene and will optionally incorporate an “O” ring to seal. In this configuration, it is obviously recognized that the tube would turn while screwing the riser into place.

Yet another variation, an over-molded threaded connector, is shown in FIG. 10, which is similar to that shown and described previously with reference to FIG. 8, where an over-molded nut was shown. The threaded connector is formed by analogous processing to that described previously for nose cones, the mold design being different. The over-molded threaded connector 63 is shown affixed to tube 18, the connector being threaded 65 and having a shoulder 62. The inner surfaces of the barrel portion 68 and radiused taper 66 are used to affix the nut in a leak-proof manner to the corresponding section of the outer surface of tubing element 18. This threaded connector in a preferred embodiment will be glass-filled polyethylene.

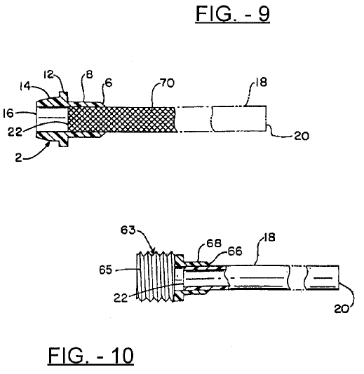

In FIG. 9, yet another embodiment of this invention is shown wherein an overbraid 70 has been applied to the tube prior to the over-molding process. The over braiding could be fiberglass, nylon webbing, stainless steel, etc.

What has been described above, is a process for over-molding profiles (particularly tubes) which comprises the steps flash heating of at least a portion of a tube of a first polymer profile crosslinked to at least 65%, followed shortly thereafter by inserting the heat-activated profile into a mold for overmolding a subsequent second profile. The mold, which is a split mold, will contain by necessity, a void, the geometry of which defines the overmolded profile. A second polymer is injection molded over at least a portion of the heat-activated first polymeric profile in the void of the mold and the polymers are crosslinked by using any of the cross-linking methodologies well known in the art. Optionally, the first polymeric profile is corona treated prior to the step of flash heating.

In a preferred embodiment, the first and second polymers are polyethylene and independently crosslinked to an initial degree. For the tube this initial degree will be at least 65%, whereas for the over-molded polymer, this initial degree may be minimal or zero, although it may range to a value less than about 60%. Post injection over-molding, the over-molded polymer is further crosslinked to a higher degree, which may ultimately be approximately the same as the final cross-linking percentage as that of the tube. The density of the polymers will impact the degree of flexibility of the product, and by using the process described; it is possible to tailor the characteristics of the final product.

As seen in the Figures, the sealing surface region is selected from the group consisting of a cup-shaped void and a radiused void and the tube contacting region is an essentially tubular void. In a more preferred embodiment, an annular shelf is interposed between the sealing surface region and the tube contacting region. In one aspect of the invention, the tube polymer will be over braided with a mesh, the mesh being either a woven or open mesh.

At times, it may be desirable to insert a nut onto the first polymer after the step of injection molding. Optionally, it is possible to mold a retaining ring onto the first polymer tube by heating a region posterior of the nut until it becomes soft, and at least one end of the tube is compressed along a longitudinal axis of the tube, such as described in U.S. Pat. No. 4,803,033. As taught in the patent, the tube is preheated at a precise area and gripping dies are used to compress the heated area. Upon compression, the heated area is forced to bulge out and fold to form the flange or bellows. A mandrel is inserted into the tube prior to the compression to insure that the tube bulges outwardly.

In another embodiment of this invention, it is possible to over-mold a nut or a threaded connector over one end of the tube, rather than the sealing surface discussed previously. The process involves the same steps with the essential difference being in the mold design, which would contain a void which comprises an internally threaded engaging surface region at a base of the mandrel. In a preferred embodiment, an n-sided shelf if interposed between the internally threaded engaging surface region and the tube contacting region and n is an integer value greater than or equal to 4.

The best mode for carrying out the invention has been described for the purposes of illustrating the best mode known to the applicant at the time. The examples are illustrative only and not meant to limit the invention, as measured by the scope and spirit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for injection over-molding a second profile of a second polymer onto a first cross-linked profile of a first polymer comprising the steps of:
heating at least a portion of said first cross-linked profile, said first polymer cross-linked to at least 65% to a temperature which raises the temperature of a skin of said portion of said first cross-linked profile from a first temperature to a second higher temperature for a duration sufficient to heat said cross-linked portion to said second temperature, said second temperature being below the temperature at which said first polymer begins to degrade;
inserting at least a portion of said heated portion of said cross-linked profile while said heated cross-linked profile portion is still in a heated condition, at least partially into a mold, said mold containing a void for receiving a second polymer, the void co-acting with the first cross-linked profile to define an over-molding profile; and
injection molding said second polymer over at least a portion of the heated portion of said first cross-linked profile into the void of the mold.

2. The process of claim 1 which further comprises the step of
cross-linking said second polymer from an initial degree of cross-linking to a final degree of cross-linking.

3. The process of claim 1 wherein
the step of inserting further comprises at least partially positioning said first profile onto a mandrel.

4. The process of claim 1 wherein the first and second polymers are polyethylene.

5. The process of claim 4 wherein
a final degree of cross-linking of said second polymer is greater than 65%.

6. The process of claim 5 wherein
a final degree of cross-linking of said second polymer is greater than 70%.

7. The process of claim 1 wherein
said second polymer is at least partially crosslinked before the step of cross-linking.

8. The process of claim 7 wherein
said first and second polymers are cross-linked to approximately the same final degree.

9. The process of claim 1 which further comprises
the step of pre-treating said skin of said portion of said first polymer, said pretreatment selected from the group consisting of corona, ozone and flame treatments.

10. A process for injection over-molding cross-linked tubes comprising the steps of:
pre-treating at least a portion of a first profile of a first polymer cross-linked to at least 65%, said pretreatment selected from the group consisting of corona, ozone and flame treatments;
heating at least a portion of said corona-treated portion of said first profile to a temperature which raises the temperature of a skin of said portion of said first polymer from a first temperature to a second higher temperature for a duration sufficient to said second temperature, said second temperature being below a temperature at which said first polymer begins to degrade;
inserting at least a portion of said heated portion of said first cross-linked profile while said heated portion is still in a heated condition, at least partially into a mold, said mold containing a void for receiving a second polymer, the void co-acting with the first cross-linked profile to define an over-molding profile; and
injection molding a second polymer over at least a portion of the heated portion of the first cross-linked profile in the void of the mold.

11. The process of claim 10 which further comprises the step of
cross-linking said second polymer from an initial degree of cross-linking to a final degree of cross-linking.

12. The process of claim 10 wherein the first and second polymers are polyethylene.

13. The process of claim 12 wherein
a final degree of cross-linking of said second polymer is greater than 65%.

14. The process of claim 13 wherein
a final degree of cross-linking of said second polymer is greater than 70%.

15. The process of claim 10 wherein
said second polymer is at least partially crosslinked before the step of cross-linking.

16. The process of claim 15 wherein
said first and second polymers are cross-linked to approximately the same final degree.

17. A process for injection over-molding a second profile onto a first cross-linked profile comprising the steps of:
activating at least a portion of a skin surface of said first profile comprised of a first polymer, said first polymer cross-linked to at least 65% with an activation means so that said skin surface of said cross-linked portion forms a material-to-material bond with an injection overmolded polymer comprising a second polymer;
inserting at least a portion of said activated cross-linked portion of said first profile while said heated portion is still in an activated condition, at least partially into a mold, said mold containing a void for receiving said second polymer, the void co-acting with the first cross-linked profile to define a second over-molding profile; and
injection molding said second over-molding profile over at least a portion of the activated portion of said first profile in the void of the mold forming said material-to-material bond with said first profile.

18. The process of claim 17 which further comprises the step of
cross-linking said second profile to a final degree of cross-linking.

19. The process of claim 17 wherein said step of activating comprises
raising a temperature of said skin of said portion of said first polymer from a first temperature to a second higher temperature for a duration sufficient to heat said portion to said second temperature, said second temperature being below the temperature at which said first polymer begins to degrade.

20. The process of claim 17 which further comprises the step of
cross-linking said second polymer from an initial degree of cross-linking to a final degree of cross-linking.

21. The process of claim 17 wherein
the step of inserting further comprises at least partially positioning said first profile onto a mandrel.

22. The process of claim 17 wherein the first and second polymers are polyethylene.

23. The process of claim 22 wherein
a final degree of cross-linking of said second polymer is greater than 65%.

24. The process of claim 23 wherein
a final degree of cross-linking of said second polymer is greater than 70%.

25. The process of claim 17 wherein
said second polymer is at least partially crosslinked before the step of cross-linking.

26. The process of claim 25 wherein
said first and second polymers are cross-linked to approximately the same final degree.

27. The process of claim 17 which further comprises
the step of pre-treating said skin of said portion of said first polymer, said pretreatment selected from the group consisting of corona, ozone and flame treatments.

28. A process for injection over-molding cross-linked tubes comprising the steps of:
activating at least a portion of a skin surface of a tube of a first polymer cross-linked to at least 65% with an activation means so that said skin surface of said portion forms a material-to-material bond with an injection overmolded second polymer;
inserting at least a portion of said activated portion of said tube having an inner diameter while said heated portion is still in an activated condition, at least partially into a mold and at least partially onto a cylindrical mandrel, the mandrel having a base and a tip, an outer diameter of said mandrel dimensioned so as to allow the inner diameter of the tube to slide thereon, said mold containing a void for receiving a second polymer, the void co-acting with the mandrel and the tube to define an over-molding shape; and
injection molding a second polymer over the tube and the mandrel in the void of the mold forming said material-to-material bond with said first polymer.

29. The process of claim 28 wherein said step of activating comprises
raising a temperature of said skin of said portion of said first polymer from a first temperature to a second higher temperature for a duration sufficient to heat said portion to said second temperature, said second temperature being below the temperature at which said first polymer begins to degrade.

30. The process of claim 28 which further comprises the step of
cross-linking said second polymer from an initial degree of cross-linking to a final degree of cross-linking.

31. The process of claim 28 wherein the first and second polymers are polyethylene.

32. The process of claim 31 wherein
a final degree of cross-linking of said second polymer is greater than 65%.

33. The process of claim 32 wherein
a final degree of cross-linking of said second polymer is greater than 70%.

34. The process of claim 28 wherein
said second polymer is at least partially crosslinked before the step of cross-linking.

35. The process of claim 34 wherein
said first and second polymers are cross-linked to approximately the same final degree.

36. The process of claim 28 which further comprises
the step of pre-treating said skin of said portion of said first polymer, said pretreatment selected from the group consisting of corona, ozone and flame treatments.
